(19) United States
(12) Patent Application Publication
(10) Pub. No.: US 2009/0026757 A1
(43) Pub. Date: Jan. 29, 2009

(54) RISER ASSEMBLY AND METHOD OF ASSEMBLY THEREFOR

(76) Inventor: Robin N. Borland, Smethport, PA (US)

Correspondence Address: FAY SHARPE LLP, 1100 SUPERIOR AVENUE, SEVENTH FLOOR, CLEVELAND, OH, 44114, US

(21) Appl. No.: 12/062,280

(22) Filed: Apr. 3, 2008

Related U.S. Application Data
(60) Provisional application No. 60/951,677, filed on Jul. 24, 2007.

(51) Int. Cl. F16L 33/20; F16L 55/00

(52) U.S. Cl. 285/31; 285/55; 285/334.3; 285/80; 285/420

(57) ABSTRACT

An improved gas riser assembly for transmitting gas from an underground gas service line to a meter manifold includes an elongated plastic tube having a first end and a second end. The first end is adapted to be connected below ground to the underground gas service line and the second end is adapted to be disposed above ground. A protective casing is annularly received about the elongated plastic tube. The protective casing has a first end adapted to be disposed below ground and a second end disposed above ground. An adapter is sealingly connected to the second end of the elongated plastic tube for fluidly connecting the elongated plastic tube to the meter manifold. The adapter is also sealingly and weldiessly connected to the second end of the protective casing. To assemble the gas riser, an insert member of the adapter is connected to the second end of the elongated plastic tube. The insert member with the elongated plastic tube connected thereto is inserted into the second end of the protective casing until the insert member protrudes from the first end of the protective casing. A cover member of the adapter is threadedly connected to the insert member. The cover member is threadedly advanced along the insert member to capture a radial flange of the protective casing between the cover member and the insert member thereby securing the insert member and the cover member to the protective casing.

This application claims the priority benefit of U.S. provisional application Ser. No. 60/951,677, filed Jul. 24, 2007, the disclosure of which is incorporated herein by reference.

### BACKGROUND

The present disclosure generally relates to gas transmission assemblies and more particularly to gas risers used in transmitting natural gas from a buried underground gas line to a delivery point. In one embodiment, a improved riser assembly that does not require welding and method of assembly therefor are provided for fluidly connecting a buried underground gas line to a meter manifold. Though the present disclosure will describe the afore-described embodiment in particular detail, it is to be appreciated that the subject matter described herein has broader applications and may be advantageously employed in related environments and applications.

U.S. Pat. No. 5,590,914 is commonly owned by the assignee of the present application and the details of that patent are incorporated herein by reference. It generally illustrates a gas riser assembly where natural gas is supplied from a gas main, through a buried service line, and eventually to the riser assembly. The riser assembly extends from an underground connection with the service line, through an elbow region, to a vertically disposed pipe that communicates with a manifold of an above-ground gas meter.

The gas riser assembly can be either factory-assembled or intended for assembly in the field. In either case, the riser assembly typically includes a double-walled conduit comprising an inner, plastic tube or casing received inside a rigid, outer casing. The inner casing defines the fluid passage for the gas as it is transported from the service line to the manifold. The riser assembly is connected to the manifold in a fluid tight manner so that a sealed passageway is provided from the underground connection with the service line to the manifold. The outer casing is often required to be a protective metal or steel pipe for protecting the above-ground portion of the gas riser assembly from possible damage or puncture. Further, the outer casing is often required to be secured to the plastic inner casing in a gas tight manner.

Often an adapter or adapter nipple is provided at an upper end of the riser assembly. The adapter connects to the above-ground ends of the inner and outer casings and connects these casing to the meter manifold. In particular, the adapter fluidly connects the inner casing to the meter manifold in a fluid tight manner and secures the steel outer casing at or near its above-ground termination to the plastic inner casing. Additionally, the adapter, which is typically formed of steel, continues to provide a steel encased gas passageway to the meter manifold. In conventional riser assemblies, the steel outer casing is typically welded to the adapter which necessitates welding capabilities and personnel when assembling the riser assembly, whether in a factory or during a field installation.

### SUMMARY

According to one aspect, an improved gas riser assembly is provided for transmitting gas from an underground gas service line to a meter manifold. More particularly, in accordance with this aspect, the riser assembly comprises an elongated plastic tube having a first end and a second end. The first end is adapted to be connected below ground to the underground gas service line and the second end is adapted to be disposed above ground. A protective casing is annularly received about the elongated plastic tube. The protective casing has a first end adapted to be disposed below ground and a second end adapted to be disposed above ground. An adapter is sealingly connected to the second end of the elongated plastic tube for fluidly connecting the elongated plastic tube to the meter manifold. The adapter is also sealingly and weldlessly connected to the second end of the protective casing.

The adapter can annularly seal between the protective casing and the elongated plastic tube adjacent the second end of the protective casing, if desired.

Also, if desired, the adapter can comprise an insert member and a nipple member. When so comprised, the insert member can have a first axial portion to which the second end of the plastic tube is secured and a second axial portion having external threads therealong. The nipple member can have internal threads for threadedly engaging the external threads of the insert member and external threads for threadedly engaging the meter manifold. The protective casing can be formed with a radial flange and the insert and nipple members can be configured to capture the radial flange therebetween when the insert and nipple members are threadedly secured to one another.

One or both of the insert member and the protective casing can be configured to prevent relative rotation between the insert member and the protective casing if desired.

Also, if desirable, the nipple member can be formed of cast iron and all connections, including between the plastic tube and the adapter and between the protective casing and the adapter, can be weldless connections.

According to another aspect, the foregoing improved riser assembly can be assembled as follows. The insert member, particularly its first axial portion, can be connected to the plastic tube at the plastic tube second end. The insert member with the plastic tube attached thereto can then be inserted into the protective casing second end and moved along the protective casing until the insert member protrudes from the protective casing first end. If necessary (e.g., when one or both of the insert member and protective casing are configured to prevent relative rotation), the insert member and the protective casing can be radially aligned to fully insert the insert member and limit relative rotation between the protective casing and the insert member. Next, the nipple member can be threadedly advanced onto the insert member, particularly the second axial portion of the insert member and, when fully advanced, can capture the radial flange of the protective casing between the insert member and the nipple member.

According to yet another aspect, a gas riser assembly is provided. More particularly, in accordance with this aspect, the gas riser assembly includes an elongated inner tube having a first end adapted to be connected below ground to a service line and a second end adapted to be connected above ground. An outer casing is annularly received about the inner tube. The outer casing has a first end adapted to be disposed below ground and a second end spaced apart from the first end of the outer casing. The first end has a radially extending flange. An adapter is connected to the second ends of the inner tube and the outer casing. The adapter has a first member received within the inner tube and has a second member coupled to the first member to axially clamp the radially extending flange between the first and second members.

According to still yet another aspect, a method for assembling a gas riser is provided. More particularly, in accordance with this aspect, an insert member of an adapter is connected to one end of an elongated inner tube. The insert member with the elongated inner tube connected thereto is inserted into one end of a protective casing until the insert member protrudes from another end of the protective casing. A cover member is threadedly connected to the insert member. The cover member is threadedly advanced along the insert member to capture a radial flange of the protective casing between the cover member and the insert member thereby securing the insert member and the cover member to the protective casing.

### BRIEF DESCRIPTION OF THE DRAWINGS

FIG. 1 is a schematic representation of a natural gas distribution system from main to meter, including a prior art riser assembly.

FIG. 2 is a cross-sectional view of an improved gas riser assembly for use in a natural gas distribution system.

FIG. 3 is an enlarged partial cross-sectional view of the improved gas riser assembly of FIG. 2.

FIG. 4 is an axial cross-sectional view of an outer casing of the gas riser assembly of FIG. 2 shown in a preassembled and pre-bending state.

FIG. 5 is a partial perspective view of the outer casing of FIG. 4.

FIG. 6 is a radial cross-sectional view of the outer casing taken at the line 6-6 of FIG. 4.

FIG. 7 is an enlarged partial cross-sectional view of the outer casing of FIG. 4.

FIG. 8 is an axial cross-sectional view of an insert member of the gas riser assembly of FIG. 2.

FIG. 9 is an axial elevational view of the insert member of FIG. 8

FIG. 10 is an axial cross-sectional view of a nipple member of the gas riser assembly of FIG. 2.

FIG. 11 is a radial end elevational view of the nipple member of FIG. 10.

FIG. 12 is an axial elevational view of the nipple member of FIG. 10.

FIG. 13 is a perspective view of the nipple member of FIG. 10.

### DETAILED DESCRIPTION

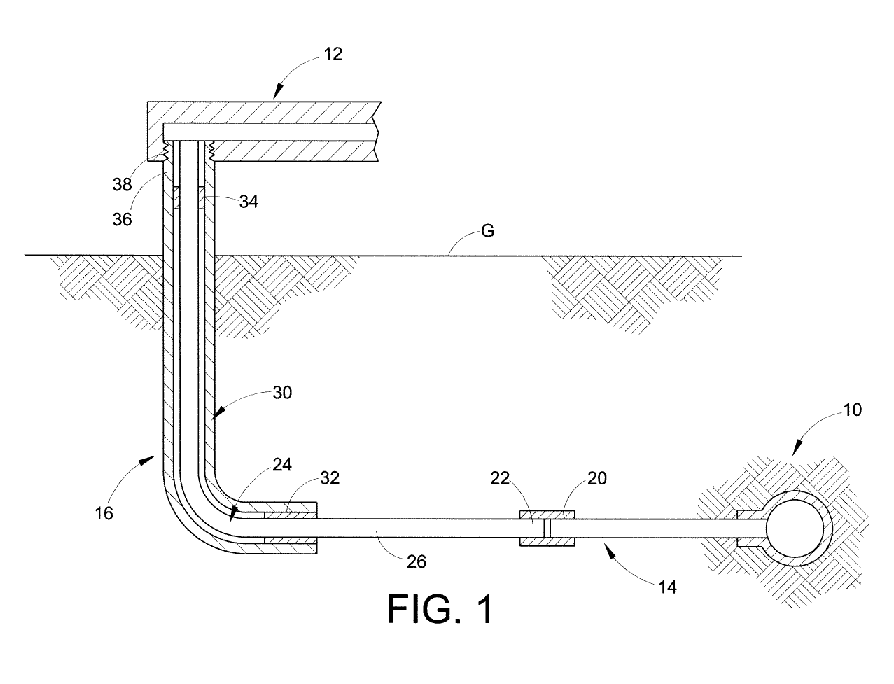

Referring now to the drawings wherein the showings are for purposes of illustrating one or more exemplary embodiments, FIG. 1 shows a main gas supply line 10 that communicates with a manifold or meter bar 12 associated with a residential or commercial establishment via a buried service line 14 and a prior art gas riser assembly 16. More particularly, natural gas or the like is supplied from the main 10 to a first end of the buried service line 14. A second end of the buried service line 14 is connected to the gas riser assembly 16 by a conventional coupling 20, such as a stab-type coupling. The coupling 20 can be a separate component or formed integrally with either the buried service line 14 or the gas riser assembly 16. The gas riser assembly 16 directs supplied natural gas from the buried service line 14 to the manifold 12. A shut-off valve and/or a pressure reducer (neither shown) can be operatively positioned between the gas riser assembly 16 and the manifold 12 if so desired.

More specifically, a first end 22 of an inner plastic conduit, tube or casing 24 is received in the coupling 20 opposite the service line 14. As shown, a portion 26 of the inner tube 24 which includes the first end 22 can extend outwardly from a second or outer conduit, tube or casing 30, the portion 26 being buried below ground G. Typically, the inner and outer casings 24,30 are bent in the form of an elbow for directing gas transmitted thereby from the buried line 14 upward toward the manifold 12. The inner and outer casings 24,30 can be maintained in spaced relation by means of annular spacers 32,34. Additionally, an upper end 36 of the outer casing 30 can be adapted for connection to the manifold 12. For example, as shown, external threads 38 can be provided on the upper end 36 of the outer casing 30 for connection to the manifold 12. In this configuration, gas can be transported from the main 10, through the service line 14, and through the inner casing 24 to the manifold 12 where it is metered before entry into an associated residential or commercial establishment.

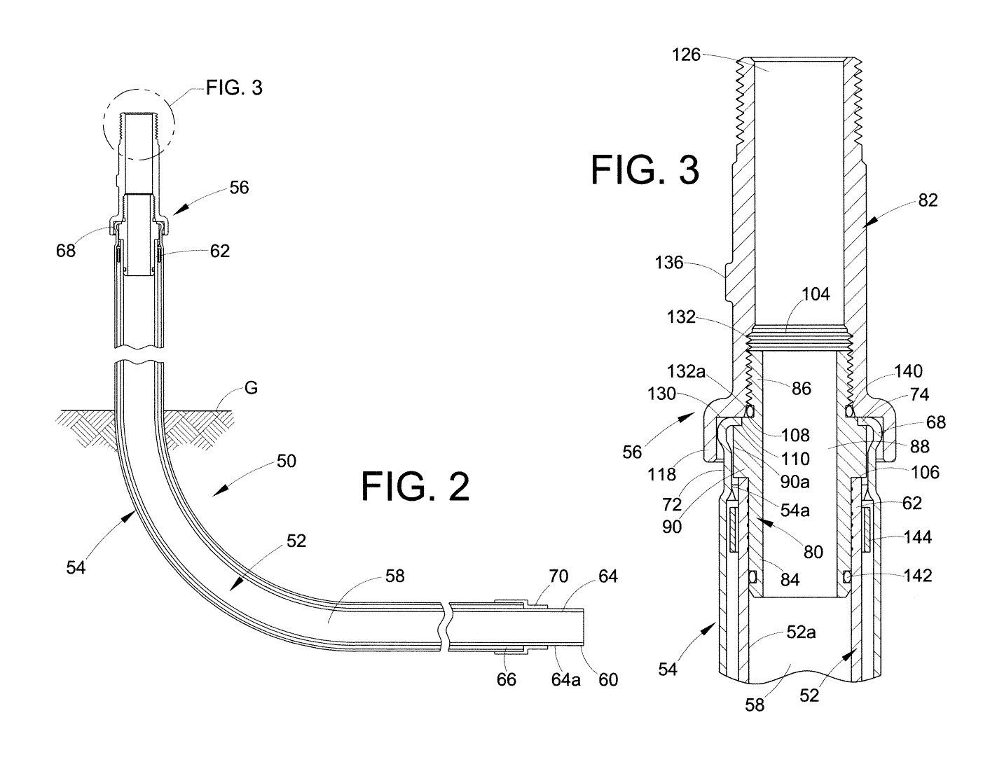

With reference now to FIGS. 2 and 3, an improved riser assembly 50 is illustrated for transmitting gas from a buried service line, such as underground gas service line 14, to a meter manifold, such as manifold 12. The riser assembly 50 includes an elongated inner casing or tube 52, which can be formed of plastic (such as polyethylene), an outer protective casing 54, which can be formed of steel, and an adapter assembly 56 for connecting the inner and outer casings 52,54 to a manifold. The inner casing or conduit 52 is hollow and tubular and defines a conduit passageway 58 therealong. The outer casing 54 is likewise hollow and tubular and is disposed annularly about the inner casing 52 in the form of a protective sleeve. The casings 52,54 can be generally bent and L-shaped (e.g., as shown) for directing and transmitting supplied gas from a buried line upward and out of the ground G toward an above-ground manifold, though other configurations are possible. At least the inner casing 52 sealingly connects to the adapter assembly 56 as will be discussed in further detail below.

Like the prior art riser assembly 16 of FIG. 1, the inner casing 52 has a first or underground end 60 is adapted to be connected below ground to an underground service line (e.g., line 14). For example, the end 60 can be received in a coupling (e.g., coupling 20) for connecting the riser assembly 50, and particularly the inner casing 52, to a buried service line. The inner casing 52 also has a second end 62 adapted to be disposed above ground and secured to the adapter assembly 56 as will be described in more detail below. An underground portion 64 of the inner casing 52, i.e., a portion of the inner casing that is to be buried underground, can extend axially outwardly from the outer casing 54. When assembled as shown in FIG. 2, the protective casing 54 can be annularly received about the inner casing 52. Like the inner casing 52, the outer casing 54 has a first or underground end 66 adapted to be disposed below ground G and a second end 68 adapted to be disposed above ground. A moisture seal 70 can be disposed at or adjacent the first end 66 of the outer casing 54 to connect and seal between the outer casing 54 and the inner casing 52, particularly with an exterior surface 64a of the inner casing underground portion 64, to prevent moisture or other contaminants from entering annularly between the inner and outer casings 52,54 at the area of the outer casing underground end 66.

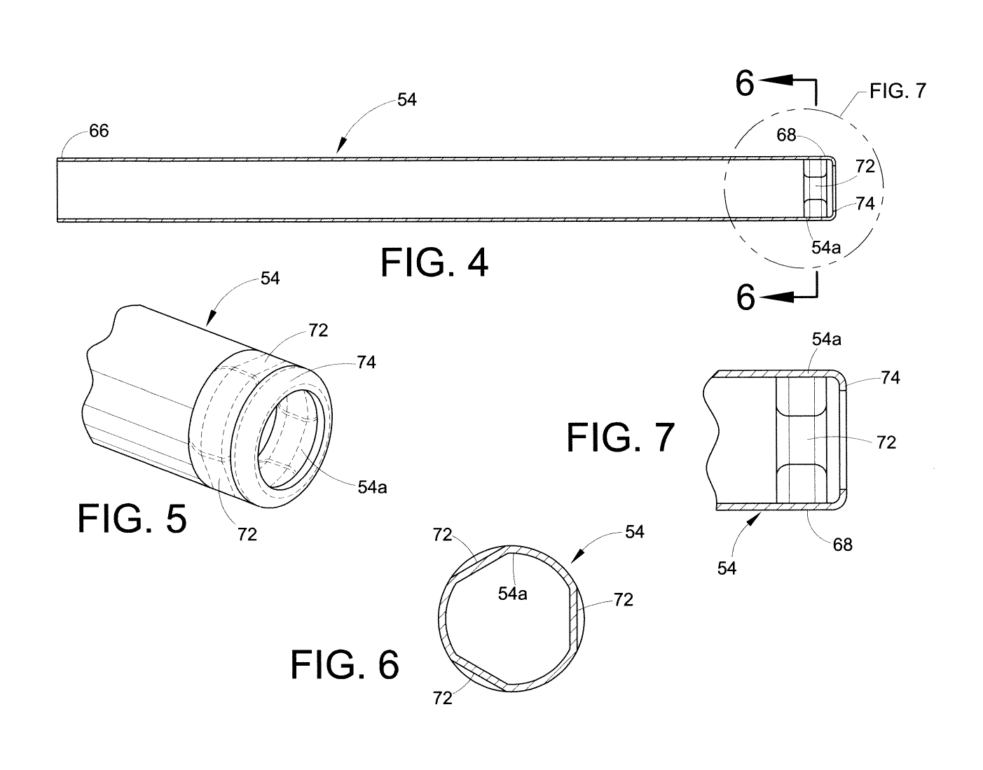

FIGS. 4-7 are further illustrations of the outer casing 54 showing it in a preassembled and pre-bending state. When annularly disposed or received over the inner casing 52, the outer casing 54 generally extends from the adapter assembly 56 to at least ground level G. Though FIG. 2 shows the outer casing 54 extending from the adapter assembly 56 to end 66, with end 66 spaced axially inwardly from inner casing end 60, it is to be appreciated that the outer casing 54 could be contiguous with the inner casing 52 or could extend to some other location, preferably below ground, along the inner casing 52 than that illustrated in FIG. 2. As will be described in more detail below, the outer casing 54 can include a nonrotatable feature for cooperating with the adapter 56 so as to prevent relative rotation between the outer casing 54 and the adapter 56. For example, as best shown in FIGS. 5 and 6, the outer casing 54 can include flat wall portions 72 (three in the illustrated embodiment) at second end 68, i.e., the end connected to the adapter assembly 56. The wall portions 72, which can be formed by pre-crimping the outer casing 54, can nonrotatably cooperate with the adapter assembly 56 as will be described in more detail below. Also at the second end 68, the outer casing 54 can include an inwardly extending radial flange 74 for connecting with the adapter assembly 56 in the manner described below. In particular, the radial flange 74 extends radially inwardly from a main wall portion 54a of the outer casing 54.

As already mentioned, the outer casing 54 can be made of steel (or some other ferrous material), which can serve to suitably protect the plastic inner casing 52 extending above ground as is often mandated by local codes or regulations. Alternatively, the outer casing 54 could be formed of some other suitable rigid material. Additionally, particularly when the outer casing 54 is made of steel, the outer casing 54 can be coated with an anticorrosive coating, such as a fusion bonded epoxy coating, a thermoplastic polyamide powder coating (such as the Rilsan® coating sold by Arkema, Inc. of Philadelphia, Pa.), a polyester coating or some other corrosion resistive coating, though this is not required.

With specific reference to FIG. 3, the adapter assembly 56, also referred to herein as simply an adapter, sealingly connects to the second end 62 of the inner casing for fluidly connecting the inner casing 52 to a meter manifold. The adapter assembly 56 also sealingly and weldlessly connects to the second end 68 of the protective casing 54. Thus, the adapter assembly 56 is connected to the second ends 62,68 of the casings 52,54. In addition, in the illustrated embodiment, the adapter assembly 56 annularly seals between the protective casing 54 and the inner casing 52 adjacent the second end 68 of the protective casing 54.

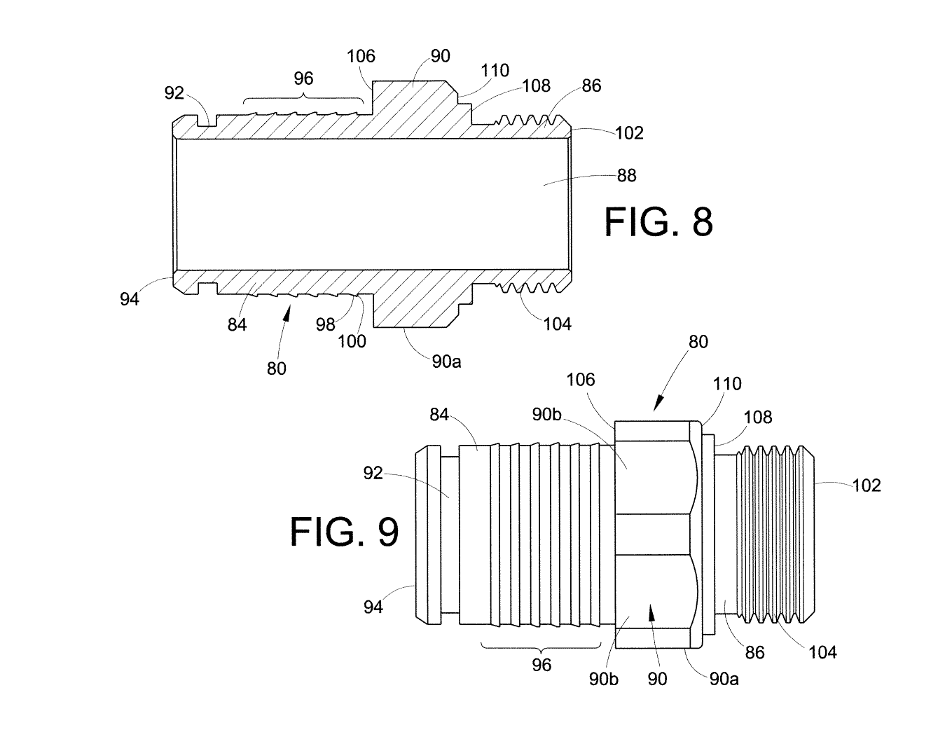

In particular, the adapter assembly 56 includes a first or insert member 80 and a second or nipple member 82 that together connect to the casings 52,54 and connect the casings to a manifold (e.g., manifold 12). The insert member 80 and the nipple member 82 can be configured to capture the radial flange 74 axially therebetween. More specifically, in the illustrated embodiment, the insert member 80 can be received within the inner casing 52, particularly the second end 62 of the inner casing 52, and the nipple member 82 can be coupled to the insert member 80 to axially clamp the radially extending flange 74 of the outer casing 54 between the members 80,82. More particularly, with additional reference to FIGS. 8 and 9, the insert member 80 includes a first axial portion 84 to which the inner casing 52 is connected (particularly, the second end 62 of the inner casing 52) and a second axial portion 86 which is threadedly connected to the nipple member 82. An insert member passageway 88 extends axially through the insert member 80 for transmitting gas from the inner casing 52 to the nipple member 82. Separating and disposed between the first and second portions 84,86 is a radially enlarged portion 90 (also referred to herein as an external radial flange), which in the illustrated embodiment has a hexagonal configuration. The insert member 80 can be formed of steel and finished with flash plated zinc, though other materials and finishes could be used.

The first axial portion 84 includes a circumferential groove 92 disposed adjacent a first end 94 of the insert member 80. Spaced axially inwardly along the first portion 84 relative to the groove 92 is a plurality of axially spaced circumferential barbs 96 (six shown in the illustrated embodiment, though any number could be used) extending radially outward for securely connecting the adapter assembly 56 to the inner casing 52. Each of the barbs 96 includes a tapered surface 98 facing the first end 94 and a shoulder 100 disposed on a backside of the tapered surface 98 facing the radially enlarged portion 90. As will be described in more detail below, the barbs 96 facilitate coupling of the insert member 80 to the inner casing 52. Beginning at or adjacent a second end 102 in the illustrated embodiment, the second axial portion 86 includes external threads 104 extending along a substantial portion thereof for threaded engagement with the nipple member 82. The radial flange or portion 90 forms an inner casing or tube shoulder 106 axially adjacent the first axial portion 84 against which the second end 62 of the inner casing 52 can abut. The flange or portion 90 further forms a flange shoulder 108 for capturing the outer casing radial flange 74 together with the nipple member 82. Still further, the flange or portion 90 can form a nipple shoulder 110 for engaging and/or sealing with the nipple member 82 when the flange 74 is captured between the members 80,82.

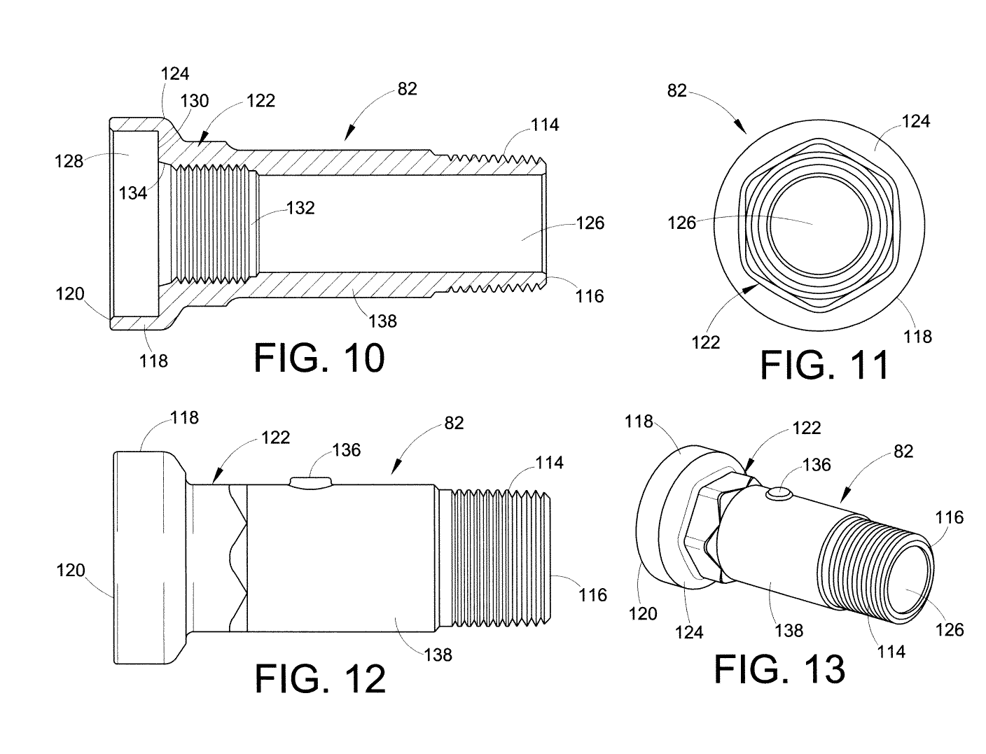

Turning to FIGS. 10-13, the nipple member 82, also referred to herein as a cover member, includes external threads 114 shown as extending axially inwardly from a first end 116 in the illustrated embodiment, for threaded connection to a meter manifold (e.g., manifold 12). An enlarged radial head portion 118 is disposed at a second end 120. A tool engaging portion 122 is disposed axially adjacent and inward relative to the head portion 118. In the illustrated embodiment, the tool engaging portion has a hexagonal configuration adapted to be engaged and rotated by an appropriate tool (e.g., a wrench). A transition surface portion 124 disposed between the engaging portion 122 and the radial head portion 118 forms together therewith a bell-shape adjacent the second end 120. Briefly returning reference to FIG. 3, this bell-shape deflects water, such as rain water, away from the connection area of the riser assembly 50 (i.e., the area at which the casings 52,54 connect to the adapter assembly 56, particularly the insert member 80 and the nipple member 82).

A nipple passageway 126 extends axially through the nipple member 82 from the first end 116 to the second end 120. The passageway 126 includes a counterbored portion 128 defined by shoulder 130, an internally threaded portion 132 having threads for threaded cooperation with the external threads 104 of the insert member 80, and a countersink portion 134 disposed axially between the portions 126 and 130. The nipple member 82 can be formed of cast iron and can be externally coated. For example, the nipple member 82 can be externally coated with a fusion bonded epoxy, zinc galvanized, zinc plated or some other external treatment.

A threaded radial protrusion or boss 136 extends radially outward from a shaft portion 138 of the nipple member 82 at a location axially spaced between the threads 114 and the tool engaging portion 122. The boss 136 allows for an optional bypass tap (e.g., ⅛ NPT) operation. Some customers or end-users of the riser assembly 50 may desire a bypass port be provided to facilitate changing out of a meter attached to the riser assembly 50. This could be done through a secondary drill and tap operation into the boss 136 and could be plugged when not in use.

With reference back to FIGS. 2 and 3, the riser assembly 50 is shown in its assembled state, wherein the insert member 80 and the nipple member 82 are threadedly secured to one another, and particularly the internal threads 132 of the nipple member 82 are threadedly secured to the external threads 104 on the insert member 80. In this configuration (i.e., the insert member 80 and the nipple member 82 being threadedly secured to one another), the radial flange 74 of the outer casing 54 can be captured between the insert member 80 and the nipple member 82 thereby connecting the adapter assembly 56 to the outer casing 54. Specifically, the radial flange 74 is axially captured between the shoulder 110 of the insert member 80 and the shoulder 130 of the nipple member 82 when the nipple member 82 and the insert member 80 are fully threadedly engaged with one another. Thus, at least one of the nipple member 82 and the insert member 80 is threadedly advanced relative to the other to capture the radially flange axially between the members 80,82.

When the one or both of the nipple member 82 and the insert member 80 is fully advanced relative to the other, the radial flange 74 can be sealingly captured between the members 80,82, which results in the adapter being sealingly and weldlessly connected to the outer casing 54, particularly the second end 68 of the outer casing 54. A seal, such as the illustrated O-ring seal 140, can also be used to seal between the insert member 80 and the nipple member 82. In the illustrated embodiment, the seal 140 is disposed between the nipple member 82 and the insert member 80 to seal therebetween. More particularly, the seal 140 can be annularly received about the second axial portion 86 and axially captured between the shoulder 108 of the insert member 80 and surface 134a defining the countersink portion 134 of the nipple member 82.

As shown, the adapter assembly 56 is also sealingly and weldlessly connected to the second end 62 of the inner casing 52. In particular, the first axial portion 84 of the insert member 80 is axially inserted into the second end 62 of the inner casing 52 (i.e., the second end 62 of the inner casing 52 is received sleeve-like around the first axial portion 84). The first axial portion 84 can be dimensioned to provide an interference-type fit with the inner casing 52. In addition, the barbs 96 can assist in providing a secure connection between the inner casing 52 and the insert member 80. A seal, such as illustrated annular O-ring seal 142, can be disposed radially between the insert member 80 and the inner casing 52. Specifically, the seal 142 can be received in the circumferential groove 92 of the insert member 80 for sealing between the insert member 80, particularly the first axial portion 84, and the inner casing 52, particularly inner surface 52a of the inner casing. As will be described in more detail below, a crimp ring 144 can additionally be used to further secure and/or seal the inner casing 52 and the insert member 80 to one another. In particular, the crimp ring 144 can be annularly received over the inner casing 52 and axially positioned opposite the barbs 96. Also, the crimp ring 144 can be disposed radially between the inner and outer casings 52,54. When crimped onto the inner casing 52, the crimp ring 144 further secures the adapter assembly 56 to the inner casing 52.

One or both of the adapter assembly 56 and the outer casing 54 can be configured to prevent relative rotation therebetween. In the illustrated embodiment, both of the insert member 80 of the adapter assembly 56 and the outer casing 54 are configured to cooperate with one another so as to be nonrotatable relative to one another. In one exemplary configuration, the external radial flange 90 of the insert member 80 can have a non-cylindrical external surface and the outer casing 54 can have a cooperating non-cylindrical internal surface. These non-cylindrical surfaces can cooperate with one another, when axially aligned, to prevent relative rotation between the insert member 80 and the outer casing 54. In another exemplary configuration, wherein such non-cylindrical cooperating surfaces are employed, the insert member 80 can include a flat surface portion that nonrotatably cooperates with a corresponding flat surface portion of the outer casing 54. In the illustrated embodiment, the insert member 80 includes the hexagonally configured external flange 90, which has a non-cylindrical external surface 90a comprising a plurality of flat surfaces 90b. The outer casing 54 has a cooperating non-cylindrical internal surface 54a comprising the flat wall portions 72. When axially aligned, the surfaces 90a,54a (and specifically the flat surface portions 90b and flat wall portions 72) cooperate with one another to prevent relative rotation between the insert member 80 and the outer casing 54.

A method for assembling an improved riser assembly, such as the illustrated riser assembly 50, will now be described. More particularly, to assemble the riser 50 the insert member 80 of the adapter 56 is connected to the second end 62 of the inner casing 52. Specifically, the first axial portion 84 of the insert member 80 is axially inserted into the second end 62 of the inner casing 52. The inner surface 52a of the inner casing 52 is forced over the barbs 96 which function to retain the inner casing 52 on the insert member 52. Axial insertion of the axial portion 84 can continue until the second end 62 abuts the shoulder 106 defined by the radially enlarged portion 90 of the insert member 80 adjacent or facing the first axial portion 84.

If employed, the crimp ring 144 is received sleeve-like over the inner casing 52 and axially positioned therealong so as to be aligned with the barbs 96 when the axial portion 84 of the insert member 80 is inserted in the inner casing 52. The crimp ring 144, which can be formed of steel, is then crimped onto the inner casing 52, which has the effect of crimping the inner casing 52 to the barbs 96 of the insert member 80. The arrangement of the barbs 96 and/or the crimp ring 144 prevents axial pullout of the insert member 80 from the inner casing 52. The location of the crimp ring 144 in the illustrated embodiment advantageously allows crimping on the inner casing 52, which is formed of plastic or the like and need not be painted or coated. Alternatively or in addition to the barbs 96 and/or the crimp ring 144, the insert member 80 and the inner casing 52 can be appropriately sized so as to form an interference fit therebetween which could also function to prevent axial pullout of the insert member 80 from the inner casing 52.

The subassembled inner casing 52 and insert member 80 can together be inserted and passed through the outer casing 54. More particularly, the second end 62 of the inner casing 52 with the insert member 80 attached thereto can be inserted into the first end 66 (FIG. 2) of the outer casing 54 until the second axial portion 86 of the insert member 80 protrudes from the second end 68 of the outer casing 54 and is stopped by engagement between the radial flange 74 of the outer casing 54 and the shoulder 110 of the insert member 80. Insertion of the inner casing 52 into the outer casing 54 can be done prior to bending of either casing 52,54 to ease assembly, if desired.

If so configured, the insert member 80 may need to be radially aligned with the outer casing 54 to fully insert the insert member 80 (i.e., all the shoulder 110 of the insert member 80 to abut the radial flange 74) and rotatably lock the insert member 80 and the outer casing 54 relative to one another. More particularly, in the illustrated embodiment, as the insert member 80 approaches the second end 68 of the outer casing 54 during assembly of the casings 52,54 (and specifically as the enlarged radial portion 90 having its hexagonal configuration approaches the crimped or radially inwardly extending flat wall portions 72 of the outer casing 54), the insert member 80 with the inner casing 52 attached thereto and the outer casing 54 may have to be rotatably aligned to allow the portion 90 to pass into the section of the outer casing 54 having the flat wall portions 72. Once aligned and fully inserted into the outer casing 54, cooperating engagement between the hexagonal configuration of the portion 90 and the flat portions 72 prevents relative rotation between the insert member 80 and the outer casing 54. Though the illustrated embodiment is shown and described with reference to portion 90 having hexagonal configuration cooperating with flat portions 72, it is to be understood and appreciated that other cooperating engagements or arrangements could be substituted in the riser assembly 50 for preventing relative rotation (e.g., a slot and key arrangement).

With the insert member 80 fully inserted or installed into the outer casing, the nipple member 82 can be threadedly secured or connected to the insert member 80. More particularly, the internal threaded portion 132 of the nipple member 82 is threadedly connected to the external threads 104 of the insert member 80, particularly the second axial portion 86 of the insert member 80. The nipple member 82 can be threadedly advanced along the threaded portion 132 to capture the radial flange 74 of the outer casing 54 between the members 80,82 thereby securing the members 80,82 (i.e., the adapter assembly 56) to the outer casing 54. In particular, the nipple member 82 is threadedly advanced until the shoulder 130 abuts the second end 68 of the outer casing 54, which is abutting the second shoulder 110 of the insert member 80. The flange 74 of the outer casing 54 is secured or captured between the shoulder 110 and the shoulder 130 and by this arrangement the members 80,82 forming the adapter assembly 56 are weldlessly connected to the outer casing 54 and the outer casing 54 is annularly sealed to the inner casing 52 at the outer casing second end 68. If desirable, a locking agent (not shown) can be used along the threaded connection (threads 104,132) between the insert member 80 and the nipple member 82. In one example, the locking agent is a solvent-free, single component plastic of the type which consists essentially of polyacryl ester, such as that sold under the tradename “Loctite”. Optionally, though not illustrated, the radially enlarged portion 118 of the nipple member 82 can be crimped or otherwise secured to the outer casing 54. Also optional is the employment of a tapered pin (not shown) received axially into the adapter 56 to deform the first few of threads 104 thereby permanently locking the members 80,82 together.

At some time prior to installation in a natural gas distribution system (i.e., prior to connection to a buried line and to a meter manifold), the inner and outer casings 52,54 of the riser assembly 50 can be bent into the generally L-shaped configuration illustrated in FIG. 2. As assembled, the passages 58,88,126 combine to form a continuous passageway through the illustrated riser assembly 50 with the seal 140 sealing between the passageways 88 and 126 and the seal 142 sealing between the passageways 58 and 88. The continuous passageway 58,88,126 serves to transmit gas from a buried line to a meter manifold.

When assembled, as briefly discussed above, the enlarged radial head portion 118 of the nipple member 82 axially overlaps the radial flange portion 90 of the insert member 80. Specifically, a distal end of the enlarged portion 118, which is contiguous with the nipple member end 120, is spaced apart from and positioned below the radial flange portion 90. This protects a connection area between the adapter assembly 56 and the outer casing 54 by directing environmental elements (e.g., rain water) past the connection area where the radial flange 74 is captured between the insert member 80 and the nipple member 82.

As will be appreciated by those skilled in the art, the improved riser assembly 50 described herein is weldless riser assembly in that it can be fully assembled without welding or any other similar fusing process. This advantageously enables all parts of the riser assembly 50 to be outsourced, if desired, and then collected and assembled in a common location without the need for welding technicians or the like. It will be appreciated that various of the above-disclosed and other features and functions, or alternatives thereof, may be desirably combined into many other different systems or applications. Also it is to be appreciated that various presently unforeseen or unanticipated alternatives, modifications, variations or improvements therein may be subsequently made by those skilled in the art which are also intended to be encompassed by the following claims.

1. An improved gas riser assembly for transmitting gas from an underground gas service line to a meter manifold, said riser assembly comprising:
an elongated plastic tube having a first end and a second end, the first end adapted to be connected below ground to the underground gas service line and the second end adapted to be disposed above ground;
a protective casing annularly received about said elongated plastic tube, said protective casing having a first end adapted to be disposed below ground and a second end adapted to be disposed above ground; and
an adapter sealingly connected to said second end of said elongated plastic tube for fluidly connecting said elongated plastic tube to the meter manifold, said adapter also sealingly and weldlessly connected to said second end of said protective casing.

2. The riser assembly of claim 1 wherein said adapter annularly seals between said protective casing and said elongated plastic tube adjacent said second end of said protective casing.

3. The gas riser assembly of claim 1 wherein said adapter comprises:
an insert member having a first axial portion to which said second end of said plastic tube is secured and a second axial portion having external threads therealong; and
a nipple member having internal threads for threadedly engaging said external threads of said insert member and external threads for threadedly engaging the meter manifold, a radial flange of said protective casing captured between said insert member and said nipple member when threadedly secured to one another.

4. The gas riser assembly of claim 3 wherein said radial flange extends radially inwardly from a main wall portion of said outer casing and is axially captured between a shoulder of said insert member and a shoulder of said nipple member when said nipple member and said insert member are fully threadedly engaged with one another.

5. The gas riser assembly of claim 3 wherein said first axial portion is axially inserted into said second end of said plastic tube.

6. The gas riser assembly of claim 5 wherein said insert member has an external radial flange disposed between said first axial portion and said second axial portion, said radial flange forming a tube shoulder axially adjacent said first axial portion against which said second end of said plastic tube abuts and further forming a flange shoulder that captures said radial flange together with said nipple member.

7. The gas riser assembly of claim 6 wherein said first axial portion includes a plurality of axially spaced barbs extending radially outward for securely connecting said adapter to said plastic tube.

8. The gas riser assembly of claim 7 wherein a crimp ring is annularly received over said plastic tube and axially positioned opposite said barbs, said crimp ring crimped onto said plastic tube to further secure said adapter to said plastic tube.

9. The gas riser assembly of claim 8 wherein said crimp ring is disposed radially between said plastic tube and said outer casing.

10. The gas riser assembly of claim 6 further including an annular seal disposed radially between said first axial portion and an inner surface of said plastic tube.

11. The gas riser assembly of claim 6 wherein said external radial flange has a non-cylindrical external surface and said protective casing has a cooperating non-cylindrical internal surface, said non-cylindrical surfaces cooperate with one another, when axially aligned, to prevent relative rotation between said insert member and said protective casing.

12. The gas riser assembly of claim 3 wherein a seal is disposed between said nipple member and said insert member to seal therebetween.

13. The gas riser assembly of claim 3 wherein said nipple member includes an enlarged radial head portion that axially overlaps said radial flange and has a distal end spaced apart from said radial flange for directing environmental elements past an area where said radial flange is captured between said insert member and said nipple member.

14. The gas riser assembly of claim 3 wherein said insert member and said protective casing cooperate with one another so as to be nonrotatable relative to one another.

15. The gas riser assembly of claim 14 wherein said insert member includes a flat surface portion that nonrotatably cooperates with a corresponding flat surface portion of said protective casing.

16. The gas riser assembly of claim 1 wherein said protective casing includes a radial flange, and said adapter includes an insert member connected to said second end of said elongated plastic tube and a nipple member for connecting to the meter manifold, said insert member and said nipple member configured to capture the radial flange axially therebetween.

17. The gas riser assembly of claim 16 wherein internal threads disposed on said nipple member are threadedly secured to external threads on said insert member, and at least one of said nipple member and said insert member threadedly advanced relative to the other of said nipple member and said insert member to capture said radially flange axially therebetween.

18. The gas riser assembly of claim 17 wherein said at least one of said nipple member and said insert member is fully advanced relative to said other of said nipple member and said insert member to sealingly capture said radially flange axially therebetween.

19. A gas riser assembly, comprising:
an elongated inner tube having a first end adapted to be connected below ground to a service line and a second end adapted to be connected above ground;
an outer casing annularly received about said inner tube, said outer casing having a first end adapted to be disposed below ground and a second end spaced apart from said first end of said outer casing, said first end having a radially extending flange; and
an adapter connected to said second ends of said inner tube and said outer casing, said adapter having a first member received within said inner tube and having a second member coupled to said first member to axially clamp said radially extending flange between said first and second members.

20. The gas riser of claim 19 wherein said adapter is sealingly and weldlessly connected to each of said second end of said inner tube and said second end of said outer casing.

21. The gas riser of claim 19 wherein said inner tube is formed of plastic and said outer casing is formed of a ferrous material.

22. A method for assembling a gas riser, comprising:
connecting an insert member of a adapter to one end of an elongated inner tube;
inserting said insert member with said elongated inner tube connected thereto into one end of a protective casing until said insert member protrudes from another end of said protective casing;
threadedly connect a cover member of the adapter to said insert member; and
threadedly advance said cover member along said insert member to capture a radial flange of said protective casing between said cover member and said insert member thereby securing said insert member and said cover member to said protective casing.

23. The method of claim 22 wherein inserting said insert member includes radially aligning said insert member with said protective casing to rotatably lock said insert member and said protective casing relative to one another and allow said insert member to abut said radial flange.

24. The method of claim 22 wherein said securing of said insert member and said cover member to said protective casing is weldless.
